(19) United States
(12) Patent Application Publication
(10) Pub. No.: US 2010/0057531 A1
(43) Pub. Date: Mar. 4, 2010

(54) Discovering Rarely-Planned Parts using Order Proposal Data

(75) Inventors: Derek P. Bagwell, Rochester, MN (US); Gary V. Tollers, Rochester, MN (US); Cheranellore Vasudevan, Bastrop, TX (US)

Correspondence Address: Marcia L. Doubet Law Office, P.O. Box 422859, Kissimmee, FL, 34742-2859, US

(73) Assignee: INTERNATIONAL BUSINESS MACHINES CORPORATION, Armonk, NY (US)

(21) Appl. No.: 12/203,833

(22) Filed: Sep. 3, 2008

(51) Int. Cl. G06Q 10/00

(52) U.S. Cl. 705/10; 705/28

(57) ABSTRACT

Discovering Rarely-Planned Parts using Order Proposal Data Discovering rarely-planned parts using order proposal data in a manufacturing/assembly environment. Requests for rarely-planned parts are detected by analyzing data from order proposals, providing early warning to the manufacturer prior to receiving an order that uses the parts and allowing the manufacturer to perform advance planning, ordering, and/or scheduling for the parts. The early warnings may also pertain to resources which may be associated with the parts, including testing, documentation, and so forth for supporting use of the parts in products. User-specified rules (or other conditions/constraints) may be used for defining which order proposals to analyze and/or the type of analysis to be performed.

### BACKGROUND OF THE INVENTION

The present invention relates to manufacturing environments, and deals more particularly with using order proposal data (which may be order configuration proposal data) to discover references to rarely-planned parts.

Parts planning for production manufacturing is typically based on historical order patterns and their contents. Procurement and resource allocation are typically based on projected order volumes and their types. Generally, this comprises looking at order volumes and types from previous time periods and making projections for an upcoming time period.

### BRIEF SUMMARY OF THE INVENTION

The present invention is directed to using order proposal data to discover references to rarely-planned parts. In one aspect, an embodiment of the present invention comprises: analyzing order proposal data representing at least one order, each order comprising a proposed order that is not yet a committed order, in view of at least one constraint on the order proposal data to determine whether any of at least one part which is detectable by the at least one constraint is represented in the order proposal data; and for each part which is determined to be represented in the order proposal data, providing an identification of the part in an output.

The order proposal data may be generated using an order configurator. The at least one part which is detectable by at least one constraint may be a rarely-used part. The at least one constraint may be specified as a rule. The output may be provided as input to a parts planning process. The output may further comprise a quantity of the part as represented in the order proposal data.

The at least one constraint may comprise at least one of a quantity of the part to be detected and an identifier of the part to be detected. The at least one constraint may comprise at least one of a time period in which the proposed order was created, a geography in which the proposed order was created, a customer which created the proposed order, and an ordering channel from which the proposed order was created. The at least one constraint may comprise at least one of a quote number under which the proposed order was created, a contract number under which the proposed order was created, a brand represented by the proposed order, and a combination of the at least one part with at least one additional part as represented by the proposed order. The at least one constraint may comprise at least one of a machine type model associated with the part to be detected and a feature code associated with the part to be detected, the machine type model and the feature code each being associated with at least one of a plurality of parts.

The at least one constraint may detect at least one part for which a warning referencing the part is to be generated in the output. Providing an identification of the part in an output may further comprise providing a warning, in the output, that the identified part is represented in the order proposal data. The warning may be for a parts planning process and may warn the parts planning process that the part may be reflected in an upcoming order, and in this case, the warning may enable the parts planning process to prepare for at least one of ordering the part; testing the part; preparing documentation pertaining to the part, and preparing warranty information pertaining to the part.

In another aspect, an embodiment of the present invention comprises: order proposal data persisted in a repository, the order proposal data representing at least one order, each order comprising a proposed order that is not yet a committed order; an analyzer for analyzing the order proposal data in view of at least one constraint on the order proposal data to determine whether any of at least one part which is detectable by the at least one constraint is represented in the order proposal data; and an output generator for providing, for each part which is determined to be represented in the order proposal data, an identification of the part in an output. In yet another aspect, an embodiment of the present invention comprises: analyzing order proposal data representing a plurality of proposed orders which are not yet committed orders in view of a plurality of rules, each of the rules comprising at least one constraint, to determine at least one part which is represented in the order proposal data and which matches each constraint in at least one of the rules; and providing, in an output generated for a parts planning process, an identification of each of the determined parts and a warning that the identified part is represented in the order proposal data.

An embodiment may further comprise: obtaining historical data indicating a conversion ratio of past proposed orders to past committed orders; and for each part which is determined to be represented in the order proposal data, using a quantity of that part, as represented in the order proposal data, in combination with the conversion ratio to determine a projected quantity of that part and providing the projected quantity in addition to the identification of the part in the output.

Embodiments of these and other aspects of the present invention may be provided as method, systems, and/or computer program products. It should be noted that the foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

The present invention will be described with reference to the following drawings, in which like reference numbers denote the same element throughout.

### BRIEF DESCRIPTION OF THE SEVERAL VIEWS OF THE DRAWINGS

FIG. 1 illustrates a high-level, simplified end-to-end view of an order process and its link to a parts planning process according to the prior art;

FIG. 2 illustrates a high-level, simplified end-to-end view of an order process and its link to a parts planning process according to an embodiment of the present invention;

FIG. 3 provides a flow diagram depicting operations and flows which may be used when implementing an embodiment of the present invention;

FIG. 4 depicts a sample data structure embodying rules which may be used with an embodiment of the present invention;

FIG. 5 provides a flowchart depicting logic which may be used when implementing an embodiment of the present invention;

FIG. 6 depicts a data processing system suitable for storing and/or executing program code; and

FIG. 7 depicts a representative networking environment in which one or more embodiments of the present invention may be used.

### DETAILED DESCRIPTION OF THE INVENTION

Embodiments of the present invention are directed toward discovering rarely-planned parts or manufacturing or test resources using order proposal data in a manufacturing environment. The order proposal data may be, for example, order configuration proposal data. (References herein to manufacturing are to be construed as also including assembly and test.)

Known techniques for parts planning may take into account factors including historic market dynamics, market trends, projections, product evolutions, and so forth. However, a good deal of variability and risk remain as to accurately estimating parts that will be needed for future orders and order types. An especially difficult problem is the case of rarely-planned parts, which may appear on an order all of a sudden, presenting the manufacturer with a situation where parts are needed but have not been planned. Some parts may have a considerable lead-time between ordering and receipt, and not having all of the necessary parts in stock for a customer's order may lead to delays and increased cost to the manufacturer as well as decreased customer satisfaction.

Two existing approaches for parts planning are known to the present inventors, as will now be described.

In a first known approach, human beings estimate parts that will be needed, and when those parts will be needed, based upon historical patterns and expert experience. This approach is prone to errors, however.

In a second known approach, the manufacturer awaits firm (i.e., committed) orders, firm order exceptions, marketing projections, and forecasts, and then determines what parts are needed in view of what has been ordered. For example, if a customer orders a product “ABC”, a bill-of-materials (“BOM”) may be generated by a material requirements planning (“MRP”) system to identify the parts that will be required for building this product (often referred to as “exploding” the BOM). However, this determination of what parts are needed occurs too late in the manufacturing process, especially for parts that may have a relatively long lead time, resulting in delays and cost overruns in the order fulfillment process when the necessary parts are not in stock for completing a customer's order.

By contrast, an embodiment of the present invention anticipates requests for rarely-planned parts, providing early warning to the manufacturer, which in turn may give the manufacturer time to plan for those parts before they are actually needed. Demand for the rarely-planned parts or resources is projected prior to receiving an order that uses the parts or resources, using techniques disclosed herein, which enables the manufacturer to perform advance planning, ordering, and/or scheduling of the parts or resources (which may include providing advance warning to external part suppliers). As will be discussed in more detail below, order proposal data is analyzed by an embodiment of the present invention to reveal rarely-used or rarely-planned parts that may appear in upcoming orders, which may (for example) be submitted by the manufacturer's customers in the relatively near future.

For ease of reference, the term “parts” is used herein when describing embodiments of the present invention, but this should be construed as also including other types of resources that may be needed in completing an order. As examples of a resource that is not a part, a particular rarely-planned part might require special acceptance testing, performance testing, or testing resources or personnel prior to using that part in a product, and an embodiment of the present invention may be used to provide advance warning that the manufacturer may need to plan and/or configure systems to accommodate this special testing. Another example of a resource that is not a part is special warranty information that may correspond to a rarely-planned part: an embodiment of the present invention may be used to provide advance warning that the warranty information for the rarely-planned part needs to be prepared (which may include review legal terms and conditions, creating documentation, and so forth).

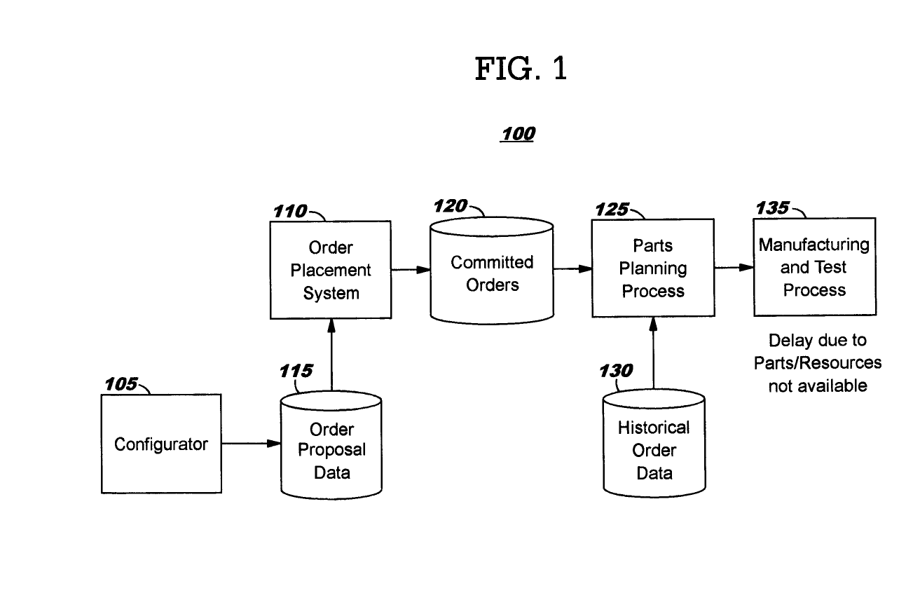

A high-level, simplified end-to-end view of a prior art order process and its link to a parts planning process is illustrated at reference number 100 in FIG. 1. As shown therein, a customer uses an order configurator 105 when preparing an order. This configurator 105 may be adapted to guide the customer through the ordering process for products, some of which may be complex and may have a number of optional features. In that case, the configurator 105 will attempt to ensure that the customer selects features which are compatible with one another. The configurator may be provided as a Web-accessible tool, and may be used by a manufacturer's end-user customers, business partners, sales personnel who assist customers, and so forth (and the term “customer” is used herein to refer to these people, for ease of reference).

As the customer uses the configurator, he or she may be considered as experimenting with configuring a product for a proposed order. The customer might try configuring various features of the product, for example, to determine the effect on the final price of the product. Order proposal data may be generated by the configurator to represent the customer's proposed order (enabling the customer to iteratively work with the proposal data, for example), and this order proposal data may be stored in an order proposal data repository 115. For example, the customer may be allowed to store information entered using the configurator, without actually submitting an order; some customers will follow through and submit a committed order from the proposal data, and some will not. This may be considered analogous to the online shopping cart provided by many Web sites in a retail consumer environment, where a consumer can store (at least temporarily) information pertaining to a potential or proposed order.

When the customer is ready to place an order, an order placement system 110 is typically used. In the approach shown in FIG. 1, the order placement system 110 retrieves the customer's previously-stored order proposal data from repository 115 and generates a committed order, which is shown in FIG. 1 as being stored in a committed orders repository 120. (Note that some amount of time may pass between the customer using the configurator to configure an order and using the order placement system to place the order.) The committed orders are provided as input to a parts planning process 125, along with historical order data from a repository 130. Information from the parts planning process 125 is passed through to the manufacturing process 135 (which, as indicated in FIG. 1, may also include a test process). As has been discussed, if an order requires use of parts which are not currently in stock (and/or resources associated with those parts), a delay will typically result in fulfilling the customer's order.

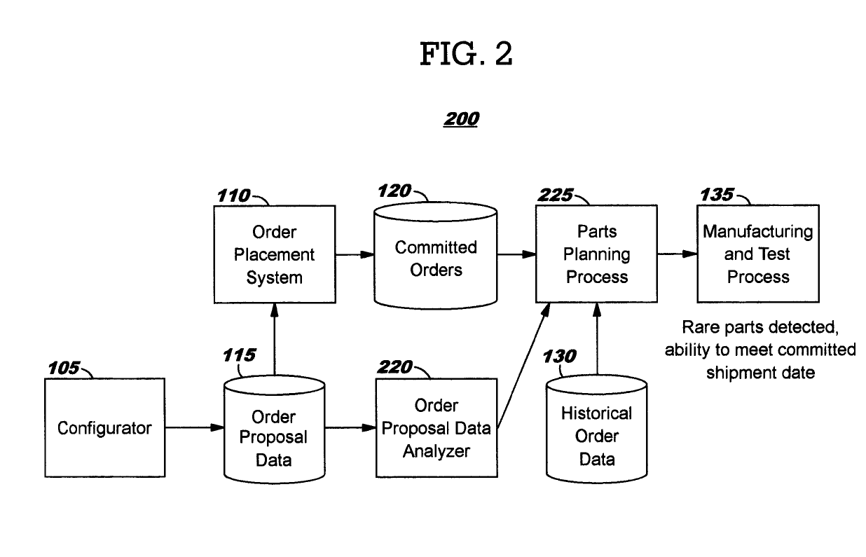

FIG. 2 illustrates a high-level, simplified end-to-end view of an order process and its link to a parts planning process at reference number 200, according to an embodiment of the present invention. In several places, FIG. 2 uses reference numbers that are identical to those in FIG. 1. This illustrates that an embodiment of the present invention may use known components for providing those functions. However, an embodiment of the present invention may alternatively use components which are created specifically for an embodiment of the present invention, and use of such alternative components is deemed to be within the scope of the present invention.

In the embodiment shown in FIG. 2, a customer uses an order configurator, which may be the same order configurator 105 shown in FIG. 1, when preparing a proposed order. The configurator generates order proposal data to represent the customer's order, and stores this order proposal data in an order proposal data repository; the order proposal data and order proposal data repository may be the same as depicted at 115 of FIG. 1.

At some point, the customer may use an order placement system, which may be the same order placement system depicted at 110 of FIG. 1, to place an order. This order placement system 110 may retrieve the customer's previously-stored order proposal data from repository 115 and generate a committed order, which is shown in FIG. 2 as being stored in a committed orders repository that may be equivalent to the committed orders repository 120 of FIG. 1.

According to an embodiment of the present invention, the order proposal data from repository 115 is also provided as input to an order proposal data analyzer 220, which in turns provides its output as input to the parts planning process 225. Historical order data may also be provided as input to the parts planning process 225, and this historical order data may be the same historical order data 130 referred to in FIG. 1. Information from the parts planning process 225 is passed through to the manufacturing process, which may be analogous to manufacturing process 135 of FIG. 1 and which may also include a test process.

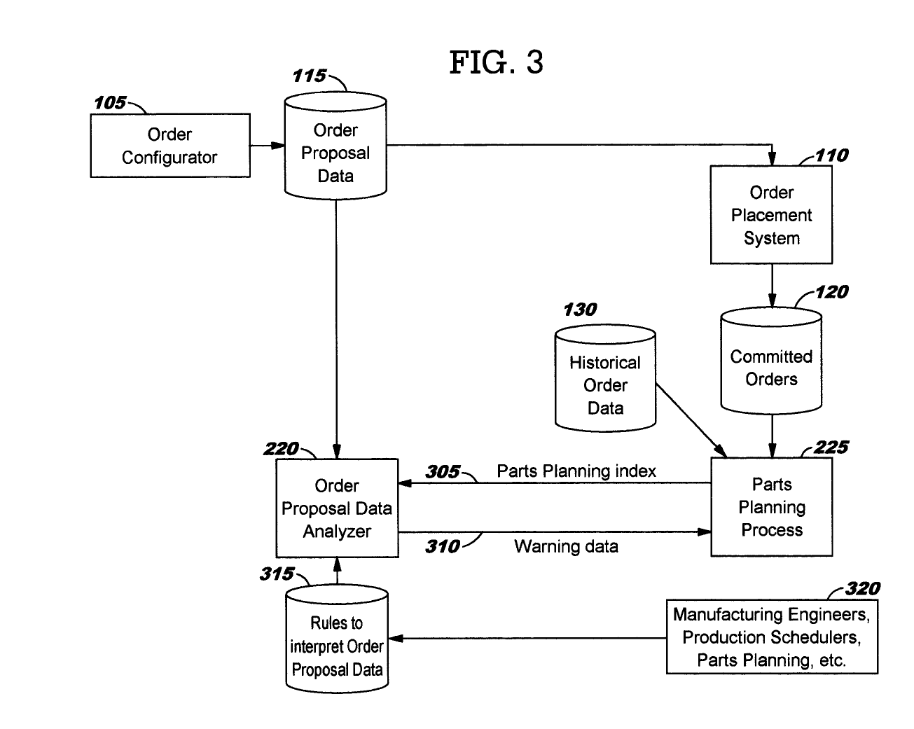

Providing the output of the order proposal data analyzer 220 to the parts planning process 225, as disclosed herein, enables the parts planning process to account for the possibility that rarely-planned parts may be needed in upcoming customer orders, thereby improving the ability of the manufacturer to proactively prepare for use of those parts and thus improving the manufacturer's ability to meet committed ship dates for the customer orders. Operation of the order proposal data analyzer 220 is discussed in more detail below, with reference to FIGS. 3-5.

Turning now to FIG. 3, a flow diagram is depicted showing operations and flows that may be used when implementing an embodiment of the present invention. Order configurator 105, order proposal data repository 115, historical order data 130, order placement system 110, committed orders 120, parts planning process 225, and order proposal data analyzer 220 have been discussed above.

An embodiment of the present invention uses the order proposal data 115 in a novel manner, supplying that data to the order proposal data analyzer 220, which attempts to locate rarely-used parts in the order proposal data.

Output from the order configurator comprises, in one approach, an identification of a machine type, model, and feature code corresponding to a product of the manufacturer. The machine type might be a “server”, for example, and the model might indicate one of several different server models that are available from this manufacturer. The feature code may provide further refinement of the model and might indicate, for example, that the customer wishes to have an upgraded disk drive as a feature of a computer that may be ordered from the manufacturer. This feature code may correlate to multiple parts which are needed to provide the upgraded disk drive, and may indicate additional components such as cables, cords, or other hardware needed to incorporate the disk drive into the computer, as well as instructions or other information that should be packaged with the computer for shipment to the customer when this disk drive is included in the computer. Accordingly, in an environment where the output of the configurator includes an identification of a machine type, model, and feature code, an input 305 from the parts planning process 225 to the order proposal data analyzer 220 may comprise a parts planning data index that provides a mapping between feature codes and part numbers which are related to each feature code. The index 305 may be used, for example, to provide an optimization over using a list comprising all potential part numbers.

Note, however, that index 305 is not strictly required in an embodiment of the present invention when used in a manufacturing environment that does not use machine type, model, and feature code as output of an order configurator. Furthermore, an alternative embodiment may omit the index 305 in a manufacturing environment that does use feature codes. In this latter scenario, an output of the order proposal data analyzer may comprise particular feature codes that are detected in the order proposal data, and the parts planning process may then interpret these feature codes to determine which parts may be needed for fulfilling upcoming orders. As another alternative, an embodiment of the present invention may detect particular feature codes in the order proposal data, and may use these features codes in combination with index 305 to generate a bill-of-materials-type list of parts for providing to the parts planning process.

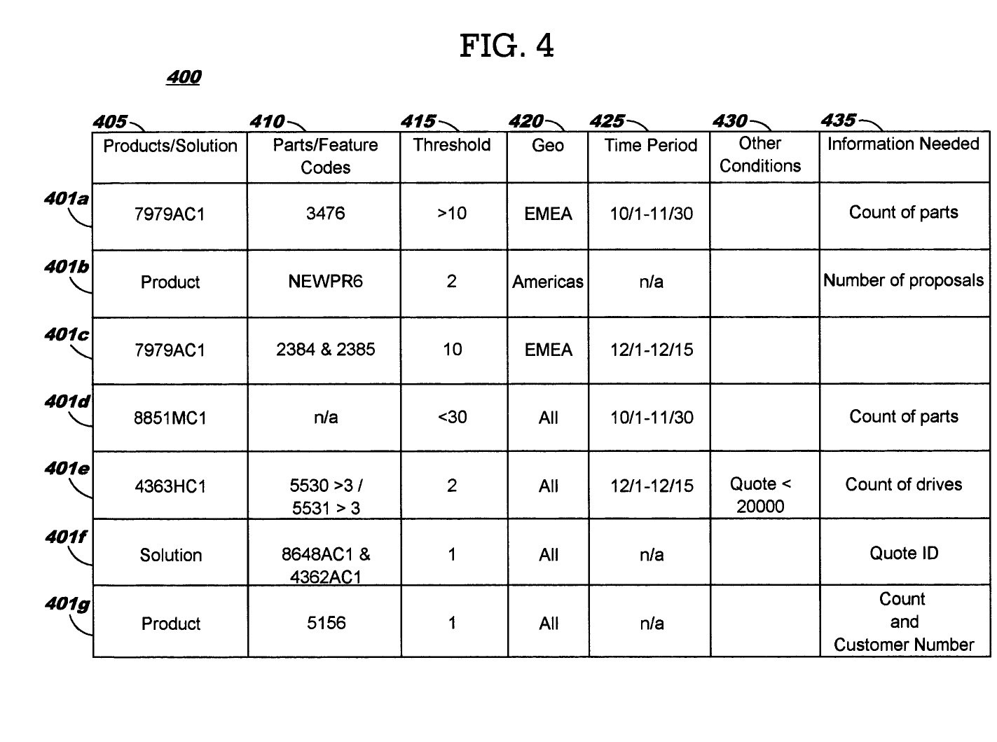

Order proposal data analyzer 220 uses, as another input, a set of conditions or constraints, shown in FIG. 3 as rules 315, for interpreting the order proposal data 115. (The constraints may be expressed in forms other than rules, without deviating from the scope of the present invention.) These rules may be generated by manufacturing engineers, production schedulers, parts planning personnel, and so forth, as indicated at 320. Sample rules are provided in FIG. 4 and are described below. The rules may specify, by way of illustration but not of limitation, at least one of the following types of information:
specific types of data that are of interest if found in the order proposal data, including specific part numbers and/or combinations of part numbers
threshold values to search for in the order proposal data
a particular time interval for which the order proposals should be analyzed
various types of scoping information for the order proposals of interest. This may include, for example, a geography from which the order proposals originate; a particular brand or brands of products reflected in the order proposal data; a particular order channel (such as a distributor, reseller, and so forth) through which the order proposal was created; and/or a special contract or purchase order under which an order corresponding to the order proposal data would be placed, if the order becomes a committed order.

The order proposal data analyzer 220 analyzes the order proposal data 115, using the rules information 315 to locate information therein. The rules may be considered as specifying filters that narrow the order proposal data 115 to particular information that is of interest to the parts planning process. An output of this analysis is provided as input to the parts planning process, as shown at 310 in FIG. 3, and may comprise (by way of example) warnings regarding unusual data that is detected in the order proposals, unusual volumes that are detected in the order proposals, special instructions that are indicated by the order proposals (such as special tests that will need to be performed if this proposal becomes a committed order), and so forth.

The order proposal data analysis process may be triggered in various ways without deviating from the scope of the present invention. A timer-driven approach may be used, for example, whereby the analysis is performed at periodic intervals. As another example, an event-driven approach may be used, whereby the analysis is triggered upon occurrence of some event (such as an operator request, accumulation of a threshold number of order proposals, and so forth).

The order proposal data analyzer 220 may also use, as a further input (not shown in FIG. 3), statistics regarding how order proposals are converted to committed orders. For example, the manufacturer might gather statistics on number of order proposals to number of committed orders, or the percentage of order proposals involving a particular part that eventually become committed orders, and so forth, and this information may be used as an input. If the order proposal data indicates 5 potential orders for a rarely-used widget, for example, and this manufacturer's conversion rate from proposed orders to committed orders is 80 percent, an advance warning may be generated indicating that 4 of these widgets may potentially be needed.

FIG. 4 illustrates a sample data structure 400 that may be used to store rules for use with an embodiment of the present invention. A record is preferably created in data structure 400 for each set of constraints or conditions that will be used to search for and detect rarely-used parts during an analysis of the order proposal data. Multiple rows may be created for identifying a single part, as needed, if more than one set of conditions is to be used in searching for that part. It should be noted that the rows in data structure 400 are intended as examples of various rules, and are not necessarily intended as a collection of rules to be used within a single implementation. Furthermore, data structure 400 is provided by way of illustration but not of limitation: an embodiment of the present invention may use rules that are specified in an alternative form, and the entries may have fewer, additional, and/or different values than those which are illustrated in FIG. 4. As one example of an alternative form, the rules might be specified using a keyword/value pair syntax, such as “(product=“123”, part=“ABC”, . . . )”.

As shown in FIG. 4, the records in the sample data structure 400 comprise an identifier 405 of a product or solution; an identifier 410 of a part, feature code, or request for price quotation (“RPQ”); a threshold 415 indicating a quantity of interest; a geography identifier 420; a time period or date range 425; other conditions 430; and an information needed field 435. These fields will now be described.

The product or solution identifier (“ID”) 405 is a value that may be used to provide a high-level identification for a product. In row 401a, for example, a product/solution ID “7979AC1” identifies a particular type of computer. Row 401b specifies a product/solution ID of “product”, which may be used as a keyword to indicate that any product meets this portion of this filter (where the filter may be further qualified or constrained, for example, to locate the part of interest using other data specified in this row 401b). Row 401f specifies a product/solution ID of “solution”, which may be used as a keyword to indicate that a combination of products or machine type models meets this portion of this filter.

The part/feature code value 410 may be used as a further constraint, in addition to the product/solution ID 405, for locating a part of interest. The value “3476” in row 401a, for example, may be a particular part number. Or, the value might be a feature code with which a part or collection of parts can be identified when this feature code value is used as input to the index 305. In that case, an embodiment of the present invention may retrieve the collection of part numbers associated with the feature code from the index, and iteratively apply rules 315 to the resulting part numbers. Row 401c illustrates a sample syntax where more than one value can be specified for column 410. This type of syntax may be used by an embodiment of the present invention, for example, to detect when a particular combination of parts is indicated by the order proposal data. Row 401d uses a keyword of “n/a” (corresponding to a “not applicable” value), which may be used when a value in column 410 is not needed (e.g., because the product/solution ID value 405 identifies the part of interest).

The threshold 415 value may be used to indicate that order proposal data is only of interest if it reflects a particular quantity of the part. In the sample data, row 401a specifies a value of “>10”, indicating that the parts planning process will only receive a warning as output of the order proposal data analyzer if the order configuration data suggests that more than 10 of this part might be needed. Row 401d specifies a value of “<30”, indicating that a warning should be triggered if the order proposal data has less than 30 of the part identified by columns 405 and 410 (e.g., in case usage of this part is normally expected in a larger quantity). Rows 401f-401g specify a value of “1”. In one approach, using this value as a threshold may be interpreted as indicating that any reference to the associated part (i.e., the part as identified using the entries in columns 405 and 410 of these rows) in the order proposal data should trigger a warning to the parts planning process. In another approach, specifying “1” as a threshold may be interpreted as indicating that a warning should be triggered if exactly one of this part is referenced in the order proposal data.

Evaluating the order proposal data with regard to a threshold may allow a warning to be created when an unusual volume of a particular part is indicated by the proposed orders.

Geography column 420 may be used to indicate that only order proposal data pertaining to a particular geography should be used when determining whether to warn the parts planning process regarding the associated part. Rows 401d-401g specify a keyword of “All” for this value, indicating that geography is not a constraint for the rules in these rows. As one alternative to including geography column 420 in the sample data structure 400, separate rules may be created for different geographies. For example, a manufacturing plant in one geographic location may have different rules from those of a manufacturing plant in a different geographic location.

Time period column 425 may be used as a way to further narrow or constrain the set of parts that will be detected this rule. In this sample data, for example, row 401a indicates that the order proposal data of interest must correspond to the time period between October 1 and November 30. Row 401b uses a keyword of “n/a”, which may be used to indicate that a time period is not a constraint for a particular rule.

Other conditions 430 is an optional column that may be used in an embodiment of the present invention. In the sample data, row 401e specifies a value of “Quote<20000” for this column, indicating that a warning is only generated from this rule if—in addition to the other constraints in columns 405 through 425—the value of the quote in the order proposal data is less than 20,000 (e.g., less than $20,000 in cost) for the part identified using columns 405 and 410. As another example, a particular customer number of interest might be detected in the order proposal data by specifying corresponding syntax for an entry in column 430. As a further example, a particular brand might be specified as an entry in column 430, indicating that the order proposal data is of interest if it represents this brand.

The sample data structure 400 also contains a column 435 titled “Information Needed”, which may optionally be used by an embodiment of the present invention for specifying a particular type (or types) of information of interest when the constraints of this rule are met by the order proposal data. Rows 401a and 401d indicate that a count of parts matching each of these rules is to be provided as output of the order proposal data analyzer. As another example, row 401b indicates that a count of the number of proposals matching this rule is to be provided. As yet another example, row 401f indicates that an identifier value of the quote is to be provided. Row 401g provides a further example, indicating that a count of the parts from proposals matching this rule and the customer number associated with those proposals is to be provided as output of the order proposal data analyzer.

As one alternative to use of column 435, an embodiment of the present invention may be adapted for providing a predetermined portion of the order proposal data (such as part numbers and quantities, for example) as output of the order proposal data analyzer. Various types of statistical data may be provided as output of the order proposal data analyzer, according to the needs of a particular manufacturing environment, including patterns that are detected in the order proposal data or ratios of specific parts to corresponding products. An embodiment of the present invention might be adapted for detecting and warning on absence of particular parts of interest in the order proposal data, in addition to or instead of warning on presence of parts.

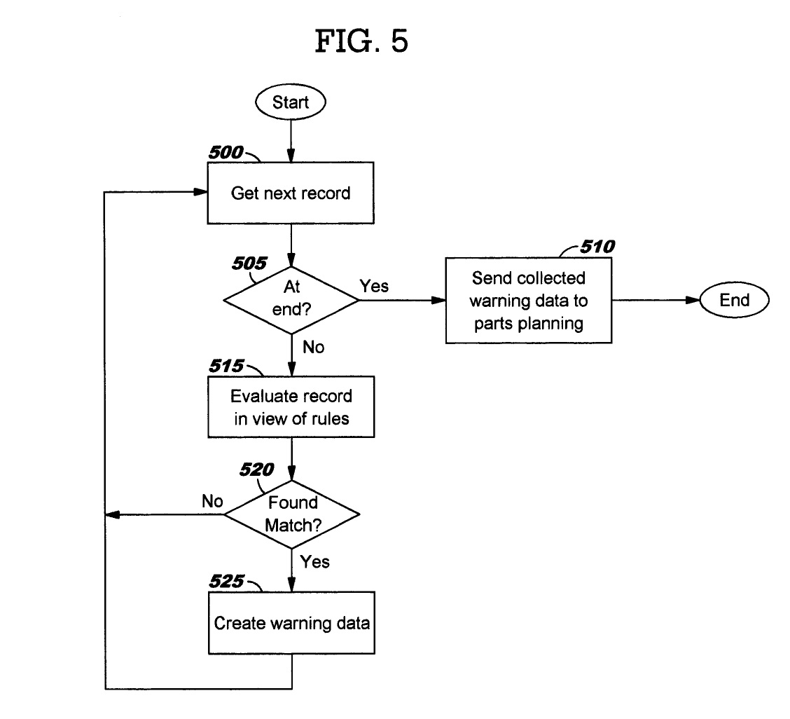

FIG. 5 provides a flowchart depicting logic which may be used when implementing an embodiment of the order proposal data analyzer disclosed herein. As noted earlier, this analysis may be triggered by a timer or event, and begins at Block 500, which gets the next record from the order proposal data repository. Block 505 tests whether the order proposal data is already at the end (i.e., whether all of the data has been analyzed for this invocation of FIG. 5). If so, then Block 510 sends the collected warning data (i.e., as collected during the processing of FIG. 5) to the parts planning process and the processing of FIG. 5 then ends. Otherwise, when the test in Block 505 has a negative result, processing continues at Block 515.

The order proposal data record is evaluated (Block 515) with regard to a set of rules, such as the rules shown in data structure 400 of FIG. 4, to determine if this record meets the constraints in any of the rules. Block 520 then tests whether a match was found. If not, control branches back to Block 500 to get another record. If the test in Block 520 indicates that the order proposal data matched a rule, on the other hand, this indicates that the order proposal data suggests a potential upcoming use of a rarely-planned part. Block 525 therefore creates warning data for use by the parts planning process and persists this data in a repository. The warning data may comprise, for example, information according to column 435 of FIG. 4. Following operation of Block 525, control branches back to Block 500.

The output sent to the parts planning process at Block 510 may be a spreadsheet, a markup language document, a file, or another data format. In one approach, this data is intended for interpretation by a human, such as parts planning personnel, to determine whether parts should be ordered or whether other planning activities should be commenced.

An embodiment of the order proposal data analyzer disclosed herein may be provided in an order configurator, in an enterprise resource planning (“ERP”) system adapted for parts planning, or in another form. As has been demonstrated, the order proposal data analysis disclosed herein enables reducing surprise demands for rarely-used parts, and analyzes the order proposal data so that it can be used to improve the parts planning process.

In addition to enabling advance planning for the parts themselves, other advantageous uses of an embodiment of the present invention include providing advance warning that particular product tests may be needed, as has been discussed above.

As will be appreciated by one of skill in the art, embodiments of the present invention may be provided as (for example) methods, systems, and/or computer program products. The invention can take the form of an entirely hardware embodiment, an entirely software embodiment, or an embodiment containing both hardware and software elements. In a preferred embodiment, the invention is implemented in software, which includes (but is not limited to) firmware, resident software, microcode, etc. Furthermore, the present invention may take the form of a computer program product which is embodied on one or more computer-usable storage media (including, but not limited to, disk storage, CD-ROM, optical storage, and so forth) having computer-usable program code embodied therein, where this computer program product may be used by or in connection with a computer or any instruction execution system. For purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (“RAM”), a read-only memory (“ROM”), a rigid magnetic disk, and an optical disk. Current examples of optical disks include compact disk read-only memory (“CD-ROM”), compact disk read/write (“CD-R/W”), and DVD.

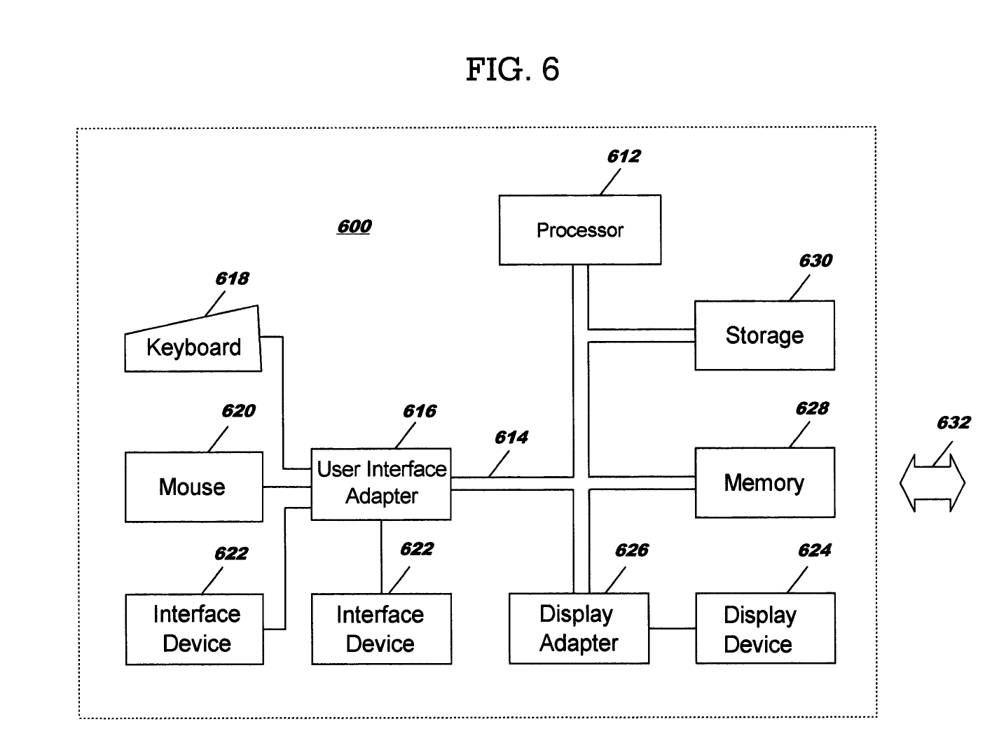

Referring now to FIG. 6, a data processing system 600 suitable for storing and/or executing program code includes at least one processor 612 coupled directly or indirectly to memory elements through a system bus 614. The memory elements can include local memory 628 employed during actual execution of the program code, bulk storage 630, and cache memories (not shown) which provide temporary storage of at least some program code in order to reduce the number of times code must be retrieved from bulk storage during execution.

Input/output (“I/O”) devices (including but not limited to keyboards 618, displays 624, pointing devices 620, other interface devices 622, etc.) can be coupled to the system either directly or through intervening I/O controllers or adapters (616, 626).

Network adapters may also be coupled to the system to enable the data processing system to become coupled to other data processing systems or remote printers or storage devices through intervening private or public networks (as shown generally at 632). Modems, cable modem attachments, wireless adapters, and Ethernet cards are just a few of the currently-available types of network adapters.

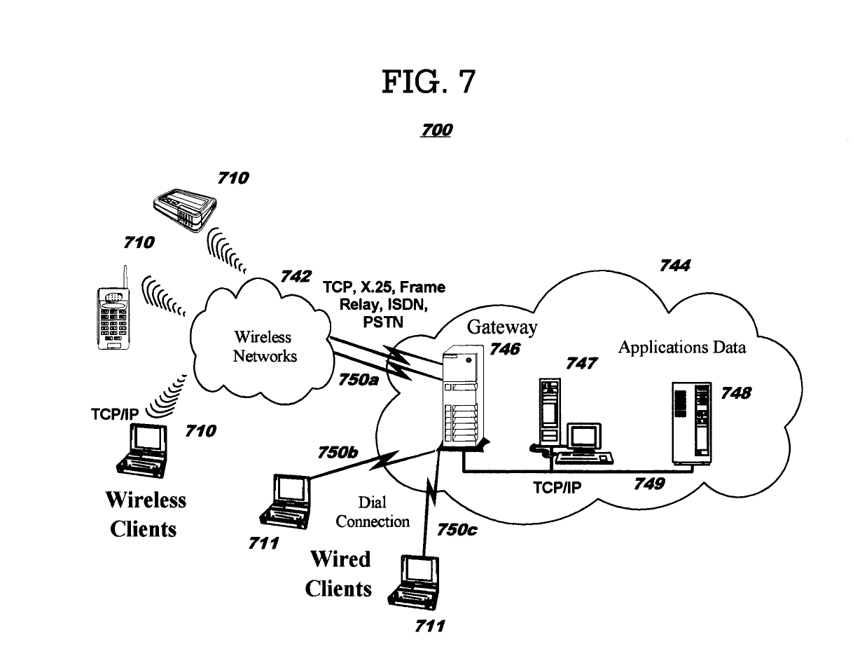

FIG. 7 illustrates a data processing network environment 700 in which the present invention may be practiced. The data processing network 700 may include a plurality of individual networks, such as wireless network 742 and wired network 744. A plurality of wireless devices 710 may communicate over wireless network 742, and a plurality of wired devices, shown in the figure (by way of illustration) as workstations 711, may communicate over wired network 744. Additionally, as those skilled in the art will appreciate, one or more local area networks (“LANs”) may be included (not shown), where a LAN may comprise a plurality of devices coupled to a host processor.

Still referring to FIG. 7, the networks 742 and 744 may also include mainframe computers or servers, such as a gateway computer 746 or application server 747 (which may access a data repository 748). A gateway computer 746 serves as a point of entry into each network, such as network 744. The gateway 746 may be preferably coupled to another network 742 by means of a communications link 750a. The gateway 746 may also be directly coupled to one or more workstations 711 using a communications link 750b, 750c, and/or may be indirectly coupled to such devices. The gateway computer 746 may be implemented utilizing an Enterprise Systems Architecture/390® computer available from IBM. Depending on the application, a midrange computer, such as an iSeries®, System i™, and so forth may be employed. (“Enterprise Systems Architecture/390” and “iSeries” are registered trademarks of IBM in the United States, other countries, or both, and “System i” is a trademark of IBM.)

The gateway computer 746 may also be coupled 749 to a storage device (such as data repository 748).

Those skilled in the art will appreciate that the gateway computer 746 may be located a great geographic distance from the network 742, and similarly, the wireless devices 710 and/or workstations 711 may be located some distance from the networks 742 and 744, respectively. For example, the network 742 may be located in California, while the gateway 746 may be located in Texas, and one or more of the workstations 711 may be located in Florida. The wireless devices 710 may connect to the wireless network 742 using a networking protocol such as the Transmission Control Protocol/Internet Protocol (“TCP/IP”) over a number of alternative connection media, such as cellular phone, radio frequency networks, satellite networks, etc. The wireless network 742 preferably connects to the gateway 746 using a network connection 750a such as TCP or User Datagram Protocol (“UDP”) over IP, X.25, Frame Relay, Integrated Services Digital Network (“ISDN”), Public Switched Telephone Network (“PSTN”), etc. The workstations 711 may connect directly to the gateway 746 using dial connections 750b or 750c. Further, the wireless network 742 and network 744 may connect to one or more other networks (not shown), in an analogous manner to that depicted in FIG. 7.

The present invention has been described with reference to flow diagrams and/or block diagrams according to embodiments of the invention. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general purpose computer, special purpose computer, embedded processor, or other programmable data processing apparatus to produce a machine, such that the instructions, which execute via the processor of the computer or other programmable data processing apparatus, create means for implementing the functions specified in the flow diagram flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flow diagram flow or flows and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flow diagram flow or flows and/or block diagram block or blocks.

While embodiments of the present invention have been described, additional variations and modifications in those embodiments may occur to those skilled in the art once they learn of the basic inventive concepts. Therefore, it is intended that the appended claims shall be construed to include the described embodiments and all such variations and modifications as fall within the spirit and scope of the invention.

1. A computer-implemented method for use in parts planning, comprising:
analyzing order proposal data representing at least one order, each order comprising a proposed order that is not yet a committed order, in view of at least one constraint on the order proposal data to determine whether any of at least one part which is detectable by the at least one constraint is represented in the order proposal data; and
for each part which is determined to be represented in the order proposal data, providing an identification of the part in an output.

2. The method according to claim 1, wherein at least one part which is detectable by at least one constraint is a rarely-used part.

3. The method according to claim 1, wherein the order proposal data is generated using an order configurator.

4. The method according to claim 1, wherein the at least one constraint is specified as a rule.

5. The method according to claim 1, wherein the output is provided as input to a parts planning process.

6. The method according to claim 1, wherein the at least one constraint comprises at least one of a quantity of the part to be detected and an identifier of the part to be detected.

7. The method according to claim 1, wherein the at least one constraint comprises at least one of a time period in which the proposed order was created, a geography in which the proposed order was created, a customer which created the proposed order, and an ordering channel from which the proposed order was created.

8. The method according to claim 1, wherein the at least one constraint comprises at least one of a quote number under which the proposed order was created, a contract number under which the proposed order was created, a brand represented by the proposed order, and a combination of the at least one part with at least one additional part as represented by the proposed order.

9. The method according to claim 1, wherein the at least one constraint comprises at least one of a machine type model associated with the part to be detected and a feature code associated with the part to be detected, the machine type model and the feature code each being associated with at least one of a plurality of parts.

10. The method according to claim 1, wherein the at least one constraint detects at least one part for which a warning referencing the part is to be generated in the output.

11. The method according to claim 1, wherein providing an identification of the part in an output further comprises providing a warning, in the output, that the identified part is represented in the order proposal data.

12. The method according to claim 11, wherein the warning is for a parts planning process and warns the parts planning process that the part may be reflected in an upcoming order.

13. The method according to claim 12, wherein the warning enables the parts planning process to prepare for at least one of ordering the part; testing the part; preparing documentation pertaining to the part, and preparing warranty information pertaining to the part.

14. The method according to claim 1, wherein the output further comprises a quantity of the part as represented in the order proposal data.

15. The method according to claim 1, further comprising:
obtaining historical data indicating a conversion ratio of past proposed orders to past committed orders; and
for each part which is determined to be represented in the order proposal data, using a quantity of that part, as represented in the order proposal data, in combination with the conversion ratio to determine a projected quantity of that part and providing the projected quantity in addition to the identification of the part in the output.

16. A system for analyzing order proposal data, comprising:
order proposal data persisted in a repository, the order proposal data representing at least one order, each order comprising a proposed order that is not yet a committed order;
an analyzer for analyzing the order proposal data in view of at least one constraint on the order proposal data to determine whether any of at least one part which is detectable by the at least one constraint is represented in the order proposal data; and
an output generator for providing, for each part which is determined to be represented in the order proposal data, an identification of the part in an output.

17. A computer-readable medium storing a computer program product for analyzing order proposal data, the computer program product comprising computer-readable program code for:
analyzing order proposal data representing at least one order, each order comprising a proposed order that is not yet a committed order, in view of at least one constraint on the order proposal data to determine whether any of at least one part which is detectable by the at least one constraint is represented in the order proposal data; and
for each part which is determined to be represented in the order proposal data, providing an identification of the part in an output.

18. A computer-implemented method for analyzing order proposal data, comprising:
analyzing order proposal data representing a plurality of proposed orders which are not yet committed orders in view of a plurality of rules, each of the rules comprising at least one constraint, to determine at least one part which is represented in the order proposal data and which matches each constraint in at least one of the rules; and
providing, in an output generated for a parts planning process, an identification of each of the determined parts and a warning that the identified part is represented in the order proposal data.
